(19) United States
(12) Patent Application Publication
(10) Pub. No.: US 2007/0233617 A1
(43) Pub. Date: Oct. 4, 2007

(54) Methods and systems for quantifying non-price characteristics of airfares

(75) Inventor: Scott R. Gillespie, Solon, OH (US)

Correspondence Address: HAHN LOESER & PARKS, LLP, One GOJO Plaza, Suite 300, AKRON, OH, 44311-1076, US

(73) Assignee: TRX, Inc., Atlanta, GA (US)

(21) Appl. No.: 11/532,320

(22) Filed: Sep. 15, 2006

Related U.S. Application Data
(60) Provisional application No. 60/718,059, filed on Sep. 16, 2005.

(51) Int. Cl. G06F 17/00

(52) U.S. Cl. 705/400

(57) ABSTRACT

The invention is directed at systems and methods which allow a user to quantify non-price characteristics of one or more airfares. The invention provides an indicator, such as an index value (or score or rating), associated with specific airfares and average airfare costs so that one can more quickly assess the non-price characteristics of one or more fares. Such an index values are useful to travelers, travel managers and analysts, and by publishers of airfares, such as GDS's (e.g., Sabre), travel agencies (e.g., American Express), internet-based travel booking sites (e.g., Orbitz) and others to supplement the buyer's ability to compare fares before making a purchase decision.

### TECHNICAL FIELD

The invention relates to systems and methods for quantifying non-price characteristics in association with airline travel services in order to facilitate the shopping, comparison, analysis or evaluation of airfare information.

### BACKGROUND OF THE INVENTION

Scheduled passenger airlines provide a wide variety of flights and airfares for purchase. Shoppers and buyers of airfares are often faced with many choices, and so would benefit from being able to more easily compare airfares on dimensions other than price. Corporation and other buyers of scheduled passenger airline services track their airline spending in order, among other reasons, to explain changes in their travel expenses and/or to identify cost saving opportunities.

Some key measures of airline spending are the average cost per ticket or the average cost per segment, and the average price per mile. Travel managers and other analysts monitor these statistics and track how they change over time, and how they compare to similar average costs between airlines in the same or similar markets. Below is an illustrative report that a travel manager may receive from a travel agency, credit card provider or other data source, where ASP means Average Segment Price. Similar reports may be generated to show Average Ticket Price and Average Price Per Mile.

| | | | | Increase |
|---|---|---|---|---|
| | | June | July | (Decrease) in |
| Market | Airline | ASP | ASP | ASP |
| CLE-ORD | AA | $243 | $297 | $54 |
| CLE-ORD | CO | $185 | $178 | $(7) |
| CLE-ORD | UA | $390 | $210 | $(180) |

However, airfares within the same or similar markets vary on many dimensions in addition to price, such as whether or not the fare is refundable; what, if any, change fee will be applied should the passenger request a voluntary change in the itinerary; how many nights, if any, the passenger must stay before returning; how many days in advance of departure the fare must be purchased, etc.

This makes it difficult for the analyst to understand if a difference in average cost per ticket (or segment or mile) between airlines in a market or group of similar markets, or within an airline over time, is due exclusively to price differentials for equivalent fares, or if the differential is caused to some extent by the non-price characteristics of the fares.

Meanwhile, travelers are often faced with a wide variety of airfares when shopping for a trip. While fares for a given trip may have the same or very similar prices, the fares may have different non-price characteristics, as noted above.

It would therefore be beneficial to have systems or methods which allow a user to quantify non-price characteristics of one or more airfares, to thereby allow comparison, tracking or monitoring of past and/or prospective air travel purchases.

### SUMMARY OF THE INVENTION

Based upon the foregoing, the present invention is therefore directed at systems and methods which allow a user to quantify non-price characteristics of one or more airfares. The present invention provides an indicator, such as an index value (or score or rating), associated with specific airfares and average airfare costs so that one could more quickly assess the non-price characteristics of one or more fares. Such an index value is useful to travelers, travel managers and analysts, and by publishers of airfares, such as GDSs (e.g., Sabre), travel agencies (e.g., American Express), internet-based travel booking sites (e.g., Orbitz) and others to supplement the buyer's ability to compare fares before making a purchase decision. In an embodiment, the invention is directed to a method for quantifying non-price characteristics of a plurality of airfares by using one or more airline's adduced fare ladder to link the airline's booking classes with an index value that generally correlate to one or more of the non-price characteristics of the plurality of airfare(s), and indicating said index values in association with a selected one of the group consisting of fare basis codes, booking classes or combinations thereof for the plurality of airfares.

In another embodiment, there is provided a method for quantifying non-price characteristics of a plurality of airfares by applying a formula to evaluate non-price characteristics of the fare's fare basis code where the at least one non-price characteristic of each fare basis code are assigned index values and the formula uses the index values to create a single index value representative of the at least one non-price characteristic in association with a selected one of the group consisting of fare basis codes, booking classes or combinations thereof for the plurality of airfares.

These and other features and advantages of the invention will become apparent upon a further reading of the description of several embodiments of the invention in conjunction with the drawings.

### BRIEF DESCRIPTION OF THE DRAWINGS

FIG. 1 is a block diagram of a system according to the invention for quantifying non-price characteristics of airfares.

FIG. 2 is a block diagram of an embodiment of a method according to the invention.

FIG. 3 is a block diagram of an alternative embodiment of a method according to the invention.

### DESCRIPTION OF THE INVENTION

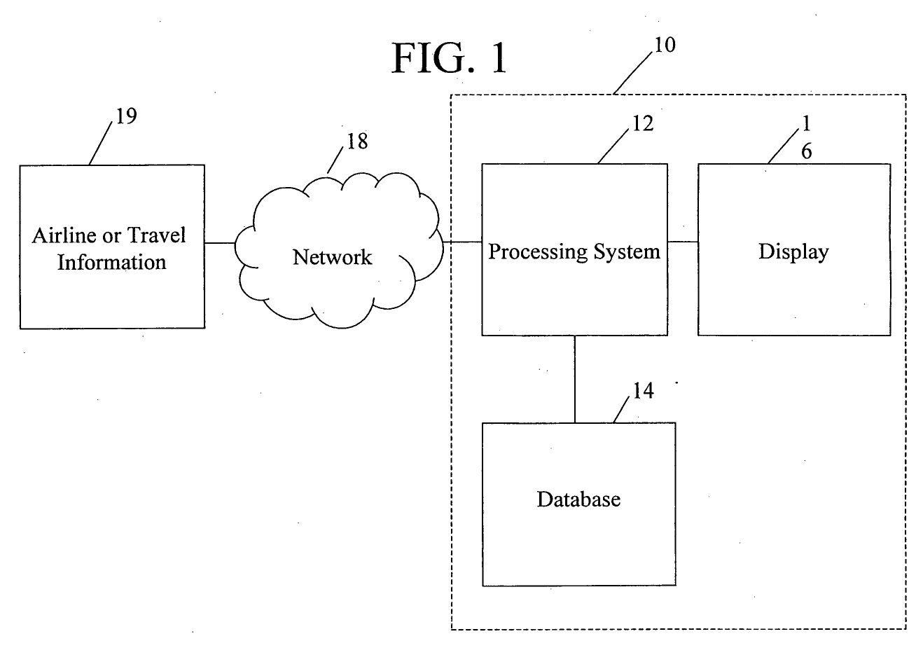

The invention will be described with reference to embodiments thereof, and is directed to methods and systems for quantifying non-price characteristics of airfares. With reference to FIG. 1, a system 10 according to the invention may comprise a processing system 12 interfaced with a database 14 having non-price characteristics of an airfare or a group of similar airfares contained therein. Information for inclusion in database 14 may be acquired in any suitable fashion, and as an example, such information may be obtained via a global information system, database or network 18, such as the Internet or a GDS, to which information is supplied from various sources of airline or travel information 19. The airline or travel information 19 may be acquired from the airlines, travel agencies, or any other suitable source. The processing system 12 is utilized to create numeric values for a fare or a group of fares, which may be referred to as an index value related to the non-price characteristics of an airfare or a group of similar airfares. Based upon the determined index values for an airfare or a group of similar airfares related to non-price characteristics thereof, the results may be displayed via display 16, or may otherwise be printed or viewed in some manner. The operations performed by the processing system 12 in conjunction with the database 14 may be implemented by software or in any suitable manner for generating the index values related to an airfare or group of similar airfares.

The invention uses some of the known or estimated non-price characteristics of an airfare or a group of similar airfares to create numeric values for a fare or group of fares, referred to as the index value. An index value can then be translated from a numeric value into a non-numeric indicator, such as “A”, “B”, red, yellow or green icons, smiley faces, etc.

An airfare (or fare) includes the price, the rules and the restrictions applicable to the purchase of the fare. The key non-price characteristics relevant to this invention are preferably the fare's cabin, capacity limits, refundability, minimum stay and advance purchase requirements, if any.

The general non-price characteristics of airfares can be adduced or otherwise determined by learning an airline's fare ladder. A fare ladder is a hierarchical construct used by airlines to organize their booking classes. Booking classes (BCs) are inventory groups or buckets to which the specific fares are assigned and sold from. Fares within a Booking Class are given a more specific inventory designator called a Fare Basis Code (FBC). Each FBC has specific rules and restrictions which govern the sale of the fare.

A fare ladder typically places the best booking class at the top, such as F for unrestricted First Class inventory, and then lists the remaining booking classes in descending order based on the cabin of the plane and/or on a combination of factors peculiar to each airline. Within each cabin, the most unrestricted fares (no capacity limits, no advance purchase, no minimum stay, fully refundable) are typically at the top and the most restricted booking class is typically at the bottom.

A typical fare ladder might be First Class F, A; Business Class J, C, D, I; Economy Class Y, B, M, H, K, Q, L, T, U, X. An airline's fare ladder may differ between its domestic (in-country), short-haul (typically neighboring countries) and long-haul (typically over-the-water) flights; and/or by the country (point of sale) from which the fare is sold, and other factors.

Generally, fares within the same Booking Class typically have similar non-price characteristics, but some airlines have and may continue to significantly vary the non-price characteristics of airfares within the same booking class.

Generally, an airfare's Fare Basis Code will begin with a letter. This left-most letter in the Fare Basis Code's alphanumeric string generally indicates the Booking Class to which the Fare Basis Code belongs. Thus, if the Fare Basis Code is known, the fare may generally be assignable to an appropriate Booking Class.

This invention relates to methods for creating an index value relating to non-price characteristics of one of more airfares. The first embodiment is referred to as the Adduced Fare Ladder Index method, and a second is referred to as the Fare Basis Code Index method.

Fare ladders can change from time to time, and fares within a booking class may have significantly different price and non-price characteristics, which may change from time to time. This makes using an airline's adduced fare ladder as the basis for creating an index score less robust than analyzing each individual fare's rules and restrictions per its fare basis code, but it is a practical option given the complexity and volume of airfare data.

An airline's fare ladder may be adduced by interviewing the airline's sales people, reviewing published information such as that contained in an Official Airlines Guide (OAG) flight schedule report, or other suitable methods.

The specific and/or general non-price characteristics of airfares (the rules and restrictions) can be obtained from published sources, such as ATPCO (Airline Tariff Publishing Company), OAG, or numerous other providers of airfare data. Using the known non-price characteristics of a fare or group of fares allows the construction of an index value using the Fare Basis Code Index method.

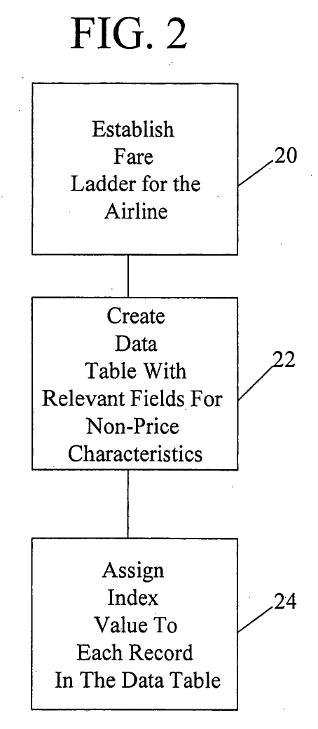

In accordance with the invention, the Adduced Fare Ladder Index method provides for creation of an index score from an adduced fare ladder. This method will be described with reference to steps of an embodiment, as follows. With reference to FIG. 2, a first step of the Adduced Fare Ladder Index method is to establish the adduced fare ladder for each airline of interest at 20. Preferably, each airline's fare ladder will be constructed in a hierarchy consistent with the airline's published fare characteristics typical among fares within the Booking Class, preferably including Cabin Class, capacity restrictions, advance purchase, minimum nights stay and refundability, among others. Preferably, either each Booking Class (e.g., F, Y, B, etc.) will have a unique rank (e.g., 1^{st}, 2^{nd}, 3^{rd}, etc.) in the fare ladder's hierarchy; although similar Booking Classes may share a common rank (e.g., Q, L, N and V may all share the 7^{th} rank on Delta Air Lines fare ladder). Other suitable constructions or hierarchies are also contemplated.

Establishing the adduced fare ladder may be done with knowledge of an airline's typical fare structures, or may be automated using defined criteria based on this knowledge. Such knowledge can be gained from a variety of sources, such as working for or interviewing employees of an airline, travel agency, travel consultancy or similar party familiar with the travel industry, or by researching publicly available information about an airline's fares and their typical or actual non-price characteristics.

Thereafter, the adduced fare ladder for an airline is used to create a data table at 22, with the following possible fields or their near-equivalent as examples, in each record: Booking Class Index Table

[image]

Those skilled in the art will recognize the option of adding other fields to this record structure, such as Cabin Class (e.g., First, Business), Stage (e.g., Domestic, Long-haul), Point Of Sale (e.g., USA, U.K.), Fare Index Group (where one or more Booking Classes are assigned to the same Fare Index Group to denote similar non-price characteristics), or other such fields as desired.

Based upon the data table, an Index Value is assigned to each record in the table at 24. Preferably, the index value assigned to a record will correlate to the non-price characteristics of the fares typically found in the record as defined by the key fields in the record structure. For example:

| Airline | Booking | Index | Illustrative Non-price characteristics |
|---|---|---|---|
| Code | Class | Value | of fares in this booking class |
| AA | F | 50 | First Class cabin, last seat availability, |
| | | | no restrictions, refundable |
| AA | A | 45 | First Class cabin, Capacity-controlled, |
| | | | 3-day advance purchase, refundable |
| AA | J | 40 | Business Class cabin, last seat availability, |
| | | | no restrictions, refundable |
| AA | C | 38 | Business Class cabin, capacity-controlled, |
| | | | 3-day advance purchase, refundable |
| AA | Y | 20 | Coach Cabin, last seat availability, |
| | | | no restrictions, refundable |
| AA | B | 18 | Coach Cabin, capacity-controlled, |
| | | | 1-day advance purchase, no minimum stay, |
| | | | refundable |
| AA | Q | 7 | Coach Cabin, capacity-controlled, |
| | | | 7-14 days advance purchase, 2-3 nights |
| | | | minimum stay, non-refundable |
| AA | V | 7 | Coach Cabin, capacity-controlled, |
| | | | 7-14 days advance purchase, 2-3 nights |
| | | | minimum stay, non-refundable |

Those skilled in the art will recognize from this illustrative table that multiple booking classes may be assigned the same index value. Doing so indicates that the typical non-price characteristics of the fares within these booking classes are generally quite similar.

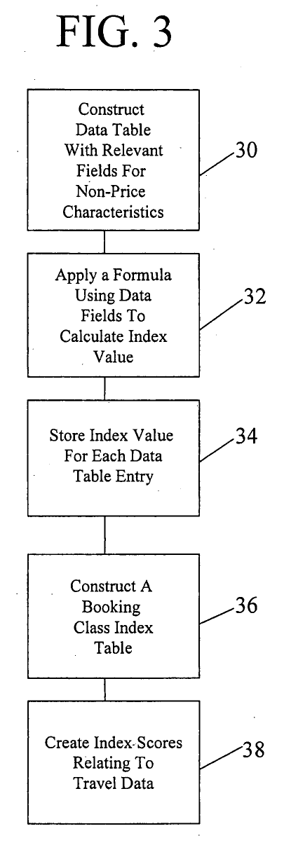

As an alternative, an index value may also be created using the Fare Basis Code Index method, wherein the following description relates to an embodiment thereof. With reference to FIG. 3, a data table is constructed at 30, with the following possible fields or their near-equivalents or other suitable fields.
1. Carrier Code (e.g., AA)
2. City Pair Code (e.g., CLE-ORD
3. Currency Code (e.g., USD, a proxy for the country in which the fare is sold)
4. Cabin Class (e.g., First or Coach)
5. Booking Class (e.g., F or M)
6. Fare Basis Code (e.g., F2 or M14NR1)
7. Refundability (e.g., Yes or No)
8. Capacity Controlled (e.g., Yes or No; or No (0), Slight (1), Moderate (2), Heavy (4)
9. Days Advance Purchase (e.g., 7)
10. Minimum Nights Stay (e.g., 2,)

Those skilled in the art will recognize that some of the fields may generally be considered more important than other of the fields and weighted accordingly, and that other fields, such as the fare's effective date, blackout dates, change fee, travel dates or other factors may also be used.

Using the data table 30, a formula using at least some of the data fields may be applied at 32 to derive an index point value (“points”) for each record's non-price characteristics. For example, a formula might use some or all or variations of these elements:

Cabin Class: First=50 points, Business Class=40 points, Coach Class=20 points.

Capacity Control: No=0 points, Yes=−1 point or Yes Slight=−1, Yes Moderate=−2, Yes Heavy=−3

Refundability: Yes=0 points, No=−3 points

Advance Purchase Days: 0 days=0 points, 1 day=−1 points, 2-3 days=−3 points; 4-7 days=−4 points, over 7 days=−6 points

Minimum Nights Stay: 0 nights=0 points; 1 night=−2 points, 2-3 nights=−3 points, 4+nights or Saturday night=−5 points

Applying the formula above to some illustrative Fare Basis Codes produces the following Index Values or Points as an example:

| Airline | Fare Basis | Index | Illustrative Non-price characteristics |
|---|---|---|---|
| Code | Code | Points | of fares in this booking class |
| AA | F1 | 50 | First Class cabin, last seat availability, |
| | | | no restrictions, refundable |
| AA | A3 | 46 | First Class cabin, Capacity-controlled, |
| | | | 3-day advance purchase, refundable |
| AA | J2 | 40 | Business Class cabin, last seat |
| | | | availability no restrictions, refundable |
| AA | C3AP | 36 | Business Class cabin, capacity- |
| | | | controlled, 3-day advance purchase, |
| | | | refundable |
| AA | Y2 | 20 | Coach Cabin, last seat availability, |
| | | | no restrictions, refundable |
| AA | B1DOM | 18 | Coach Cabin, capacity-controlled, |
| | | | 1-day advance purchase, no minimum |
| | | | stay, refundable |
| AA | Q7APNR3N | 10 | Coach Cabin, capacity-controlled, |
| | | | 7-14 days advance purchase, 2-3 nights |
| | | | minimum stay, non-refundable |
| AA | V5APNR2N | 10 | Coach Cabin, capacity-controlled, |
| | | | 5 days advance purchase, 2-3 nights |
| | | | minimum stay, non-refundable |

Those skilled in the art will recognize that more sophisticated formulas could be applied to achieve the same desired outcome—that of a quantified value derived from the non-price characteristics of the airfare being analyzed.

For example, one could construct a set of conditional formulas to represent a matrix of possibilities, where the record's final index point value is determined by the simultaneous consideration of two or more non-price characteristics. For example, one part of such a formula may take the form:

If ((Advance Purchase Days=1 and Minimum Nights Stay is between 2 and 3), OR if (Advance Purchase Days=2 and Minimum Nights Stay=1)), then subtract 2 points from the Cabin Class value.

Another type of formula that can be easily applied using the concept of index value points is that of weighting the non-price components, such that the formula gives more or less relative weight to one or more of the non-price characteristics being evaluated.

Once the formula has been applied to the record, the Index Point Value may be stored at 34, such as in a table which can then be used for comparing airfares by indicating the relative value of the record's non-price characteristics. This may be done by reporting the fare's Index Points, shown next as “Fare Index Score”, preferably along with other key characteristics of the airfare, such as:

AA CLE to ORD Depart 9:00 a.m., one-way price=$145, Fare Index Score=10

AA CLE to ORD Depart 9:00 a.m., one-way price=$180, Fare Index Score=14

One skilled in the art will recognize the ease of converting the numeric fare index values to ratings or icons, such as “Very Flexible”, “Limited Flexibility”, Red, Yellow or Green symbols, etc.

Once Index Values have been derived by the Fare Basis Code Index method, one can construct a Booking Class Index Table at 36. Doing this may involve basic statistical analysis of the fare basis codes' index values within an airline's booking class. For example, if all ten fare basis codes with American's H class are found to have a total value of 185 Index Points, then one may assign an average Index score of 18.5 to the American H class.

One skilled in the art will recognize that various alternative statistical analyses may be applied to the data, such as using the trimmed mean, or the median, or the weighted average score where one weights each fare basis code by either the number of segments or the spend associated with each fare basis code, or other similar analyses. One will also recognize the options for creating tables at the level of Airline-Stage-Booking Class; Airline-POS-Stage-Booking Class and other similar variations.

Preferably, the result is a table with a form equivalent to, with the addition of further information possible.

| Airline | Booking Class | Index Score |
|---|---|---|
| AA | Y | 20 |
| AA | B | 18 |
| CO | Q | 7 |
| UA | Y | 20 |
| UA | T | 5 |

The Booking Class Index Table may then be used to create Index Scores at 38 for the traditionally reported Average Segment Prices, Average Ticket Prices and Average Price Per Mile. Doing so typically requires historical data about an organization's past purchases of airfares. Preferably, such historical data will be in the form similar to the following table (note that the ASP field can be derived from the spend and segment fields):

Historic City Pair Data at Booking Class Level

| City Pair | Airline | Booking Class | Spend | Segments | ASP |
|---|---|---|---|---|---|
| CLEORD | AA | Y | $20,000 | 50 | $400 |
| CLEORD | AA | B | $60,000 | 300 | $200 |
| CLEORD | CO | Q | $2,500 | 20 | $125 |
| CLEORD | UA | Y | $10,000 | 25 | $400 |
| CLEORD | UA | T | $20,000 | 200 | $100 |

A typical format for reporting Average Segment Prices is at the Airline-City Pair level. Using the table above, one gets:

| City Pair | Airline | Spend | Segments | ASP |
|---|---|---|---|---|
| CLEORD | AA | $80,000 | 350 | $229 |
| CLEORD | CO | $2,500 | 20 | $125 |
| CLEORD | UA | $30,000 | 225 | $133 |

By using the Booking Class Index Table and weighting the data preferably either by segments or by spend, one can now calculate the Index Score and add it to the above table, such as:

| | | | | | Avg. Fare Index |
|---|---|---|---|---|---|
| | | | | | Score (Wtd. By |
| City Pair | Airline | Spend | Segments | ASP | Segments) |
| CLEORD | AA | $80,000 | 350 | $229 | 18.3 |
| CLEORD | CO | $2,500 | 20 | $125 | 7.0 |
| CLEORD | UA | $30,000 | 225 | $133 | 6.7 |

Using the same method of calculating a weighted average Fare Index Score, one can enhance higher-level airline spend reports by adding Fare Index statistics, such as:

| | June | June Fare | July | July Fare | ASP | Fare Index |
|---|---|---|---|---|---|---|
| Airline | ASP | Index | ASP | Index | Variance | Variance |
| AA | $243 | 18.3 | $297 | 23.4 | +$54 | +5.1 |
| CO | $185 | 14.5 | $178 | 15.2 | $(7) | +0.7 |
| UA | $390 | 27.9 | $210 | 18.6 | $(180) | (9.3) |

A formula for deriving the segment-weighted Airline-level Fare Index Score for a time period may be:

(Sum of (Airline's segments in Booking Class N×Booking Class Fare Index Score for N) divided by Airline's total segments across all booking classes) where N denotes each individual Booking Class for which the airline had segments.

In these methods according to embodiments of the invention, it is possible to establish Index Values by the Adduced Fare Ladder Index approach and/or the Fare Basis Code Index approach, which can then be communicated via different levels of fare detail. For example, a user could use either method to assign a non-price score or value to an airlines fare basis code or in relation to its booking class. Either method and either level of detail may be used, such that there would be four possible combinations based on these levels of reporting information to ultimately assign an Index Score or Value to a fare. It is also possible to derive a ratio between the fare's Price and its Index Score to provide useful information to a user. For example, the invention provides a method for relating the price of an airfare to its non-price characteristics, where the non-price characteristics of the airfare have been assigned a numerical or other value by either of the two methods described above. The steps associated with this may be as follows according to an embodiment of the invention:
1. Identify the airfare using at least the fields of: Airline, Fare Basis Code and Price, and preferably at least the field of City Pair
2. Identify the fare's non-price numerical score (Index Score) from applying either of the two methods described above.
3. Construct a ratio using the two values Price and Index Score, such as Price divided by Index Score, or Index Score divided by Price

Alternatively, the invention may provide a method for relating the average price paid for a plurality of airfare segments or airfare tickets to the Index Value relating to non-price characteristics associated with the group of fares that are used to derive the average price. This approach may utilize steps as follows:
1. Identify a group of airfares with at least one common characteristic, such as the time period within which the fare was offered or purchased, the city pair market(s) for which the fares were associated, the airline(s) associated with the fares, or other such factors that may be useful to the user.
2. Calculate or if already available, use the average price of the group's airfares to obtain an average price indicator (e.g., Average Segment Price, Average Ticket Price, or Average Price Per Mile)
3. Calculate or if already available, use the average Index Score for the group's airfares
4. Construct a ratio using the two values Average Price and Average Index Score, such as Average Price divided by Average Index Score, or Average Index Score divided by Average Price

While the invention has been described with reference to certain embodiments, it will be understood by those skilled in the art that various changes may be made and equivalence may be substituted without departing from the scope of the invention. In addition, many modifications may be made to adapt a particular situation to the teachings of the invention without departing from its scope. For example, similar techniques may be used in evaluating non-price characteristics in association with other forms of travel, or with respect to other goods or services where non-price characteristics are an importance feature to the purchasing consumer. Therefore, it is intended that the invention not be limited to the particular embodiments disclosed, but that the invention will include all embodiments falling within the scope of the appended claims.

What is claimed is:

1. A method for quantifying non-price characteristics of a plurality of airfares by using one or more airline's adduced fare ladder to link the airline's booking classes with an index value that generally correlate to one or more of the non-price characteristics of the plurality of airfare(s), and indicating said index values in association with a selected one of the group consisting of fare basis codes, booking classes or combinations thereof for the plurality of airfares.

2. The method of claim 1, further comprising the steps of:
identifying each of the plurality of airfares using information relating to the airline offering an airfare, the fare basis code for the airfare, the price of the airfare, and the city pair associated with the airfare,
identifying said score for each airfare and determining a ratio using the values of price and said score for each airfare.

3. A method of claim 1 further comprising the steps of:
determining the average price paid for a plurality of airfare segments or airfare tickets and associating said index value representative of non-price characteristics with the group of fares that are used to derive the average price.

4. The method of claim 3, wherein the step of determining the average price paid includes identifying a group of airfares with at least one common characteristic selected from the group consisting of the time period within which the fare was offered or purchased, the city pair market of markets for which the fares were associated, the airline or airlines associated with the group of airfares, or combinations thereof, and providing the average price of the group's airfares to obtain an average price indicator, and providing an average index value for said group of airfares.

5. The method according to claim 4, wherein the average price indicator is related to at least one of the group consisting of average segment price for a given travel segment, average ticket price, or average price per mile.

6. The method according to claim 5, further comprising the steps of:
providing the average index score for the group's airfares and determining a ratio using the two values of average price and average index value.

7. A method for quantifying non-price characteristics of a plurality of airfares by applying a formula to evaluate non-price characteristics of the fare's fare basis code where the at least one non-price characteristic of each fare basis code are assigned index values and the formula uses the index values to create a single index value representative of the at least one non-price characteristic in association with a selected one of the group consisting of fare basis codes, booking classes or combinations thereof for the plurality of airfares.

8. The method of claim 7, further comprising the steps of:
identifying each of the plurality of airfares using information relating to the airline offering an airfare, the fare basis code for the airfare, the price of the airfare, and the city pair associated with the airfare,
identifying said score for each airfare and determining a ratio using the values of price and said score for each airfare.

9. A method of claim 7 further comprising the steps of:
determining the average price paid for a plurality of airfare segments or airfare tickets and associating said index value representative of non-price characteristics with the group of fares that are used to derive the average price.

10. The method of claim 9, wherein the step of determining the average price paid includes identifying a group of airfares with at least one common characteristic selected from the group consisting of the time period within which the fare was offered or purchased, the city pair market of markets for which the fares were associated, the airline or airlines associated with the group of airfares, or combinations thereof, and providing the average price of the group's airfares to obtain an average price indicator, and providing an average index value for said group of airfares.

11. The method according to claim 10, wherein the average price indicator is related to at least one of the group consisting of average segment price for a given travel segment, average ticket price, or average price per mile.

12. The method according to claim 11, further comprising the steps of:
providing the average index score for the group's airfares and determining a ratio using the two values of average price and average index value.
